(19) United States
(12) Patent Application Publication
(10) Pub. No.: US 2012/0140263 A1
(43) Pub. Date: Jun. 7, 2012

(54) IMAGE PROCESSING APPARATUS, IMAGE PROCESSING SYSTEM, CONTROL METHODS THEREOF AND PROGRAMS

(75) Inventor: Yoshitaka Oba, Kawasaki-shi (JP)

(73) Assignee: CANON KABUSHIKI KAISHA, Tokyo (JP)

(21) Appl. No.: 13/297,330

(22) Filed: Nov. 16, 2011

(30) Foreign Application Priority Data
Dec. 1, 2010 (JP) 2010-268723

(51) Int. Cl. G06K 15/02

(52) U.S. Cl. 358/1.14; 358/1.15

(57) ABSTRACT

The present invention provides an image processing apparatus and an image processing system that prevent an operation contrary to an operator's intention from occurring due to conflict between instructions from a plurality of input devices, and control methods thereof. To accomplish this, the image processing apparatus of the present invention selects an input device to which a preferential use authority of the image processing apparatus is to be assigned from among a plurality of input devices in communication with the image processing apparatus, assigns the preferential use authority, receives an operation instruction transmitted from the input device, and executes a job in accordance with the received operation instruction.

### BACKGROUND OF THE INVENTION

1. Field of the Invention

The present invention relates to an image processing apparatus, an image processing system, control methods thereof and programs.

2. Description of the Related Art

Currently available image processing apparatuses are generally equipped with an input display panel provided integrally with the main body of the image processing apparatus. With a large format image processing apparatus whose main body is equipped with various paper discharge processing devices such as a finisher, the input display panel is configured to be removable from the main body so that the displayed operation procedures can be viewed from operation locations. Also, Japanese Patent Laid-Open No. 2008-236094 proposes an image processing apparatus in which functional units constituting the image processing apparatus are provided with a wireless communication function so that the combination of the functional units can be changed easily.

However, the conventional technique has the following problems. In the case where an image processing apparatus to which a plurality of input display panels can be connected receives input instructions simultaneously from the input display panels, over-writing of operation instructions may occur, resulting in operation instructions not intended by the operators. For example, if user A places an original on the auto original conveyance device of the image processing apparatus and operates the input display panel of the image processing apparatus to enter settings such as copy settings, and at the same time another user B operates another input display panel and outputs a copy execution instruction, the image processing apparatus will start copying contrary to the intention of user A.

### SUMMARY OF THE INVENTION

The present invention enables realization of an image processing apparatus and an image processing system that prevent an operation contrary to an operator's intention from occurring due to conflict between instructions from a plurality of input display devices, and control methods thereof.

One aspect of the present invention provides an image processing apparatus being capable of communicating with a plurality of input devices that request execution of a job via a wireless communication, the image processing apparatus comprising: an obtaining unit that obtains information indicating a type of job to be executed from each of the plurality of input devices; a selecting unit that selects an input device to which a preferential use authority of the image processing apparatus is to be assigned from among a plurality of input devices in communication with the image processing apparatus based on the information obtained by the obtaining unit; and a job processing unit that receives an operation instruction transmitted from the input device and executes the job in accordance with the received operation instruction.

Another aspect of the present invention provides an image processing system including an image processing apparatus and a plurality of input devices that request the image processing apparatus to execute a job via wireless communication, wherein the input devices each comprise a request unit that transmits a connection request for establishing a wireless connection with the image processing apparatus to the image processing apparatus, and the image processing apparatus comprises: an obtaining unit that obtains information indicating a type of job to be executed from each of the plurality of input devices; a selecting unit that selects an input device to which a preferential use authority of the image processing apparatus is to be assigned from among a plurality of input devices in communication with the image processing apparatus based on the information obtained by the obtaining unit; and a job processing unit that receives an operation instruction transmitted from the input device and executes the job in accordance with the received operation instruction.

Still another aspect of the present invention provides a control method of an image processing apparatus being capable of communicating with a plurality of input devices that request execution of a job via a wireless communication, the method comprising: with an obtaining unit, obtaining information indicating a type of job to be executed from each of the plurality of input devices; with a selecting unit, selecting an input device to which a preferential use authority of the image processing apparatus is to be assigned from among a plurality of input devices in communication with the image processing apparatus based on the information obtained in the obtaining step; and with a job processing unit, receiving an operation instruction transmitted from the input device and executing the job in accordance with the received operation instruction.

Yet still another aspect of the present invention provides a control method of an image processing system including an image processing apparatus and a plurality of input devices that request the image processing apparatus to execute a job via a wireless communication, the method comprising: in the input devices, with a request unit, executing a request step of transmitting a connection request for establishing a wireless connection with the image processing apparatus to the image processing apparatus, and in the image processing apparatus, with an obtaining unit, obtaining information indicating a type of job to be executed from each of the plurality of input devices; with a selecting unit, selecting an input device to which a preferential use authority of the image processing apparatus is to be assigned from among a plurality of input devices in communication with the image processing apparatus based on the information obtained in the obtaining step; and with a job processing unit, receiving an operation instruction transmitted from the input device and executing the job in accordance with the received operation instruction.

Further features of the present invention will be apparent from the following description of exemplary embodiments with reference to the attached drawings.

### BRIEF DESCRIPTION OF THE DRAWINGS

FIG. 1 is a schematic diagram showing an example of a configuration of an image processing system according to a first embodiment of the present invention.

FIG. 2 is a block diagram showing a control configuration of the image processing system according to the first embodiment.

FIG. 3 is a flowchart illustrating a processing procedure performed by an input display panel according to the first embodiment.

FIG. 4 is a flowchart illustrating a processing procedure performed by an image processing apparatus according to the first embodiment.

FIG. 5 is a diagram showing allocation of preferential use authority assigned to input display panels 300.

FIG. 6 is a flowchart illustrating details of processing for determining a terminal to which a preferential use authority is to be assigned, performed in step S5406 of FIG. 4.

FIG. 7 is a flowchart illustrating details of processing for extracting terminals to which a preferential use authority needs to be assigned, performed in step S603 of FIG. 6.

FIG. 8 is a flowchart illustrating a processing procedure performed by an image processing apparatus according to a second embodiment of the present invention.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Image Processing System

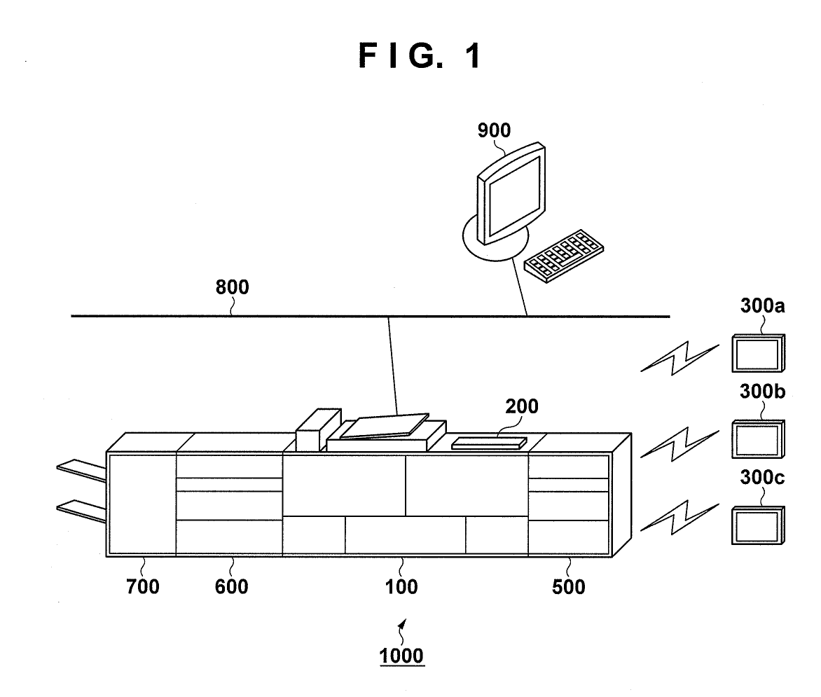

A first embodiment will be described below with reference to FIGS. 1 to 7. An overview of an image processing system 1000 according to the present embodiment will be described first with reference to FIG. 1. An image processing apparatus of the present embodiment is what is called a print on demand (POD) machine that responds to a variety of print/bookbinding requests by combining various options that enable saddle stitch binding, cutting and folding. The image processing apparatus shown in FIG. 1 is an example in which a sheet deck 500, a binder 600, and a finisher 700 are combined with an image processing apparatus main body (hereinafter referred to as a “main body”) 100.

The main body 100 is connected to a personal computer 900 via a LAN 800. The personal computer 900 generates print jobs including creating and editing a page, as well as making settings such as bookbinding, cutting and folding. The generated print jobs are sent to the main body 100 via the LAN 800. In the image processing apparatus of the present embodiment, removable input display panels (input display devices) 300 that are a feature of the present invention are wirelessly connected to the main body 100. Optional apparatuses such as the sheet deck 500, the binder 600 and the finisher 700 are not directly relevant to the present invention, and therefore detailed descriptions thereof are not given here.

Control Configuration

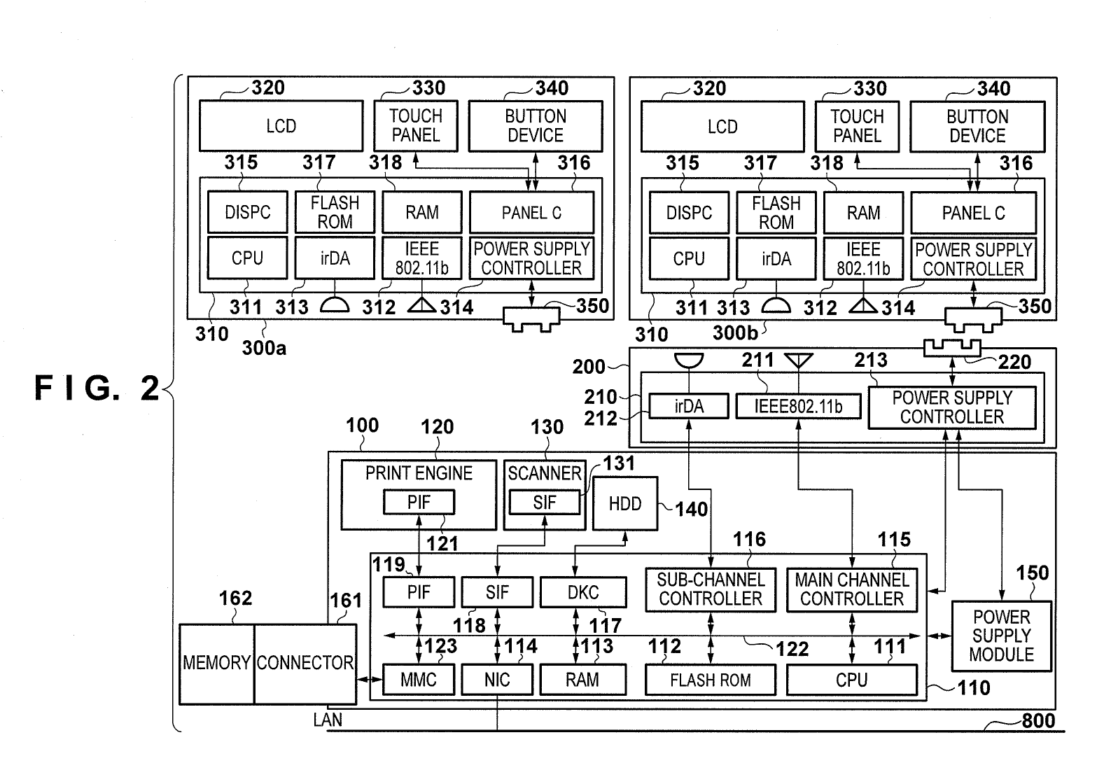

Control configurations of the main body 100, a home position apparatus 200 and the input display panels 300 that are included in the image processing system of the present embodiment will be described next with reference to FIG. 2. A description of the main body 100 will be given first. As shown in FIG. 2, the main body 100 is provided primarily with a controller board 110, a print engine 120, a scanner 130, a hard disk drive (HDD) 140 and a power supply module 150. These devices are operated by power supplied by the power supply module 150.

The controller board 110 includes a CPU 111, a flash ROM 112, a RAM 113, a network interface card (NIC) 114, a main channel controller 115, a sub-channel controller 116, a disk controller (DKC) 117, a scanner interface (SIF) 118, a printer interface (PIF) 119 and a memory controller (MMC) 123. The devices 111 to 119 and the memory controller 123 are connected via a bus 122.

The CPU 111 is a processor that performs overall control of the devices connected to the bus 122 and that executes firmware modules serving as control programs stored in the flash ROM 112 and the HDD 140. The RAM 113 functions as the main memory, a working area and the like for the CPU 111. The NIC 114 performs interactive data exchange with the personal computer 900 or other image processing apparatuses via the LAN 800. The HDD 140 is accessed via the DKC 117 and is used not only to store firmware modules but also used as a temporary storage area for images.

The scanner 130 incorporated in the main body 100 includes a reading sensor, an original conveyance mechanism and the like. The reading sensor, the original conveyance mechanism and the like are controlled based on the firmware modules executed by the CPU 111 via the SIF (scanner I/F) 118 mounted on the controller board 110 and an SIF 131 mounted on the scanner 130. As a result, an original is read by the reading sensor, and the obtained data is transferred to the controller board 110 via the SIF 131 and the SIF 118.

The print engine 120 built in the main body 100 includes an electrophotographic image forming unit, recording paper cassettes, a sheet conveyance unit and the like. A print request based on a print job is sent from the controller board 110 via the PIF (printer I/F) 119 and a PIF 121 mounted on the print engine 120. The image forming unit, the sheet conveyance unit and the like are controlled similarly based on the firmware modules executed by the CPU 111 via the PIF 119 and the PIF 121. As a result, an image corresponding to the print request can be formed on a sheet.

The main channel controller 115 and the sub-channel controller 116 are used to exchange data between the main body 100 and the removable input display panels 300, which are a feature of the present invention. A detail thereof will be described later. The memory controller 123 accesses an external memory 162 such as a USB memory or memory card via an external memory connector 161 under control of the CPU 111.

Next, the home position apparatus 200 will be described. As shown in FIG. 2, the home position apparatus 200 is constituted primarily by a main board 210 and a connector 220. The main board 210 constituting the home position apparatus 200 is constituted primarily by an IEEE 802.11b module 211, an irDA module 212 and a power supply controller 213.

The IEEE 802.11b module 211 is connected to the main channel controller 115 of the controller board 110, and mediates wireless communication with the input display panels 300 based on requests from the controller board 110. The irDA module 212 is connected to the sub-channel controller 116 of the controller board 110, and mediates infrared communication with the input display panels 300 based on requests from the controller board 110.

The power supply controller 213 is connected to the power supply module 150. The IEEE 802.11b module 211 and the irDA module 212 receive supply of power via the power supply controller 213. The power supply controller 213 is also connected to the connector 220, and supplies power to the input display panels as well when connectors 350 of the input display panels are in contact with the connector 220. The power supply controller 213 monitors the power supply state, detects whether or not the home position apparatus 200 and the input display panels have been installed, and informs the controller board 110.

Next, the input display panels 300 will be described. As shown in FIG. 2, each removable input display panel 300 is constituted primarily by a main board 310, an LCD 320, a touch panel 330, a button device 340 and a connector 350. The main board 310 is constituted primarily by a CPU 311, an IEEE 802.11b module 312, an irDA module 313, a power supply controller 314, a display controller (DISPC) 315, a panel controller (PANELC) 316, a flash ROM 317 and a RAM 318.

The modules 311 to 318 are connected by a bus, as with the controller board 110. The CPU 311 is a processor that performs overall control of the devices connected to the bus and that executes firmware modules serving as control programs stored in the flash ROM 317. The RAM 318 functions as the main memory and a working area for the CPU 311 as well as an area for video images that are displayed on the LCD 320.

The display controller (DISPC) 315, in response to a request from the CPU 311, transfers video images expanded into the RAM 318 to the LCD 320 and controls the LCD 320. As a result, the images are displayed on the LCD 320. The panel controller (PANELC) 316 controls the touch panel 330 and the button device 340 in response to a request from the CPU 311. With such control, the position pressed on the touch panel 330, a pressed key code on the button device 340, or the like is sent back to the CPU 311.

The power supply controller 314 is connected to the connector 350, and receives a supply of power from the power supply module 150 of the main body 100 when the connector 220 of the home position apparatus 200 is in contact with the connector 350, whereby a rechargeable battery (not shown) connected to the power supply controller 314 can be charged and at the same time power can be supplied to the entire input display panel 300. In the case where, for example, power is not supplied from the power supply module 150, the power from the rechargeable battery is supplied to the entire input display panel 300.

The IEEE 802.11b module 312 establishes wireless communication with the IEEE 802.11b module 211 of the home position apparatus 200 based on control of the CPU 311, and mediates communication with the main body 100. The irDA module 313 establishes infrared communication with the irDA module 212 of the home position apparatus 200 based on control of the CPU 311, and mediates communication with the main body 100.

Main Channel

Wireless communication as a main channel in the present embodiment will be described here. In the present embodiment, wireless communication as a main channel is performed in accordance with a known technique, namely, the IEEE 802.11b standard. More specifically, with the image processing system 1000 of the present embodiment, wireless communication is performed in an infrastructure mode in which the main body 100 serves as an access point (AP) and the input display panels 300 serve as terminals.

In the case where there are a plurality of main bodies within a radio wave receiving range, as in existing personal computers, ESSIDs of the available main bodies are displayed on the input display panel 300 side such that one of the main bodies can be selected. After communication with the communication partner has been established by association, the input display panel 300 of the present embodiment operates as a screen transfer type thin client. In other words, the CPU 111 of the main body 100 executes most of the actual processing and video image generation. The resulting video images are wirelessly sent from the main body 100 to the input display panel 300 with a preset protocol. The CPU 311 of the input display panel 300 that has received the video images controls the DISPC 315 so as to display the video images on the LCD 320 while expanding the received video images into the RAM 318.

Meanwhile, information regarding user operations made on the touch panel 330 and the button device 340 of the input display panel 300 is also wirelessly sent from the input display panel 300 to the main body 100 with a preset protocol. Information regarding operations includes, for example, the position pressed on the touch panel 330, a pressed key code on the button device 340 and the like. The CPU 111 of the main body 100 that has received the information regarding operations controls individual operations based on the received information. Where necessary, the CPU 111 updates the video images and sends the video images to the input display panel 300 in the manner described above. As described above, the image processing system 1000 of the present embodiment is a system in which the main body 100, or in other words, the image processing apparatus and the input display panels 300 can wirelessly communicate.

Preferential Use Authority Application Processing by Input Display Panel

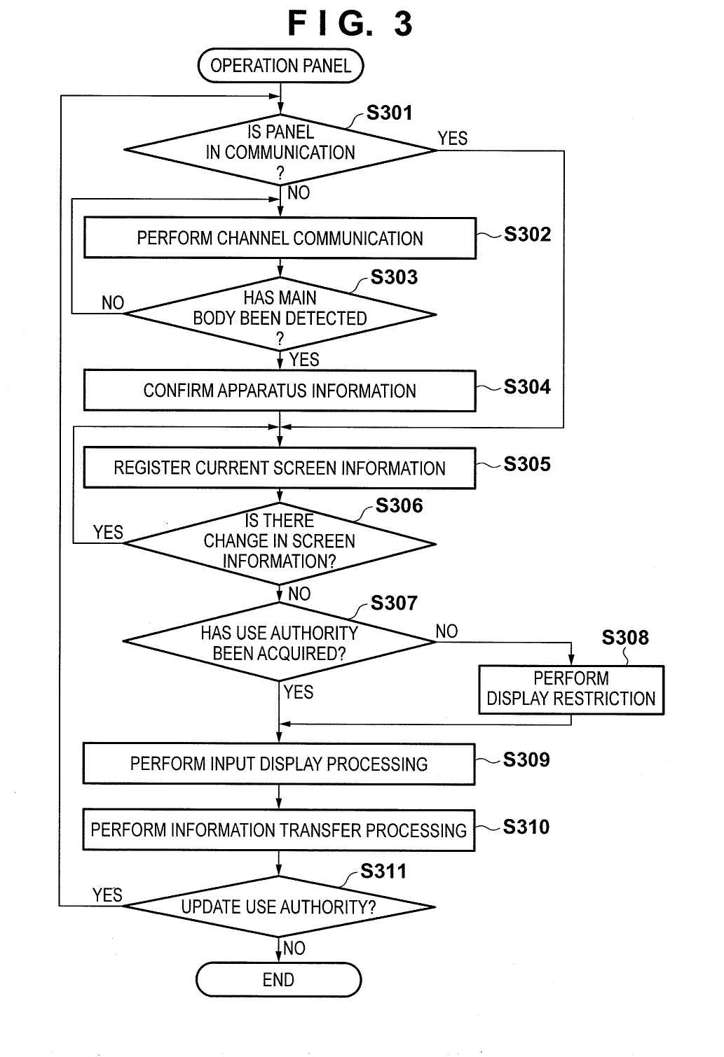

Next, preferential use authority application processing performed by the input display panel 300 will be described with reference to FIG. 3. Overall control of the processing described below is performed by the CPU 311 of the input display panel 300.

In step S301, the CPU 311 of the input display panel 300 determines the wireless communication state of the main channel and determines whether or not the input display panel 300 is in wireless communication with the main body 100. If it is determined that wireless communication as a main channel is not established (No in step S301), the processing advances to step S302, where the CPU 311 functions as a request unit and transmits to the main body 100 a request to establish main channel communication (wireless connection) with the main body 100. In the case where there are a plurality of main bodies within a range where radio waves of the main channel are received, it is desirable that ESSIDs of the available main bodies are displayed on the input display panel 300 side for the user to select one from among the ESSIDs, and the above request is transmitted to the main body of the selected ESSID.

Next, in step S303, the CPU 311 determines whether or not the main body 100 has been detected by determining whether or not a response that permits communication has been received from the main body 100, and repeats step S302 until the main body 100 is detected. If, on the other hand, it is determined that the main body 100 has been detected (Yes in step S303), the CPU 311 establishes main channel communication with the main body 100 and advances the processing to step S304.

In step S304, the CPU 311 confirms apparatus information of the main body 100 that indicates the apparatus ID, available functions and the like of the main body 100. Specifically, the CPU 311 transmits to the main body 100 an apparatus information confirmation request (a request to confirm the apparatus ID and apparatus information of the main body 100), receives the apparatus information from the main body 100, and advances the processing to step S305. If, on the other hand, it is determined in step S301 that the input display panel 300 is in wireless communication (main channel communication) with the main body 100 (Yes in step S301), the CPU 311 advances the processing to step S305.

In step S305, the CPU 311 notifies the main body 100 of currently displayed screen information. Specifically, the CPU 311 transmits to the main body 100 a request to register currently used screen information so as to register the information in the main body 100. Subsequently, in step S306, the CPU 311 determines whether or not a change in the screen information of the display controller (DISPC) 315 has been detected. If it is determined that a change has been detected, the CPU 311 returns the processing to step S305. If, on the other hand, it is determined in step S306 that no change has been detected in the screen information (No in step S306), the CPU 311 advances the processing to step S307.

In step S307, the CPU 311 determines whether a preferential use authority of the main body 100 has been acquired. If it is determined that the preferential use authority has been acquired, the CPU 311 advances the processing to step S309. If, on the other hand, it is determined that the preferential use authority has not been acquired (No in step S307), the processing advances to step S308, where the CPU 311 performs display restriction on the display controller (DISPC) 315. Specifically, the CPU 311 restricts the display contents on the screen displayed by the display controller (DISPC) 315 depending on whether the preferential use authority assigned by the main body 100 has been acquired. After that, the CPU 311 advances the processing to step S309. For example, if the preferential use authority is not acquired, the CPU 311 restricts the display contents on the screen such that operation instructions that will affect the processing of other users cannot be selected.

In step S309, the CPU 311 controls the display controller (DISPC) 315 and the PANELC 316 so as to perform control processing on data displayed on the LCD 320. Subsequently, in step S310, the CPU 311 transmits the information processed in step S309 to the main body 100. Furthermore, in step S311, the CPU 311 determines whether or not the input display panel 300 is to update the preferential use authority of the main body 100. If it is determined that the input display panel 300 is to update the preferential use authority (Yes in step S311), the CPU 311 repeats the processing from step S301 to step S311. If, on the other hand, it is determined that the input display panel 300 is not to update the preferential use authority (No in step S311), the CPU 311 ends the processing. The processing from steps S301 to S310 is repeated as long as power is supplied to the input display panel 300.

Preferential Use Authority Assignment Processing by Main Body

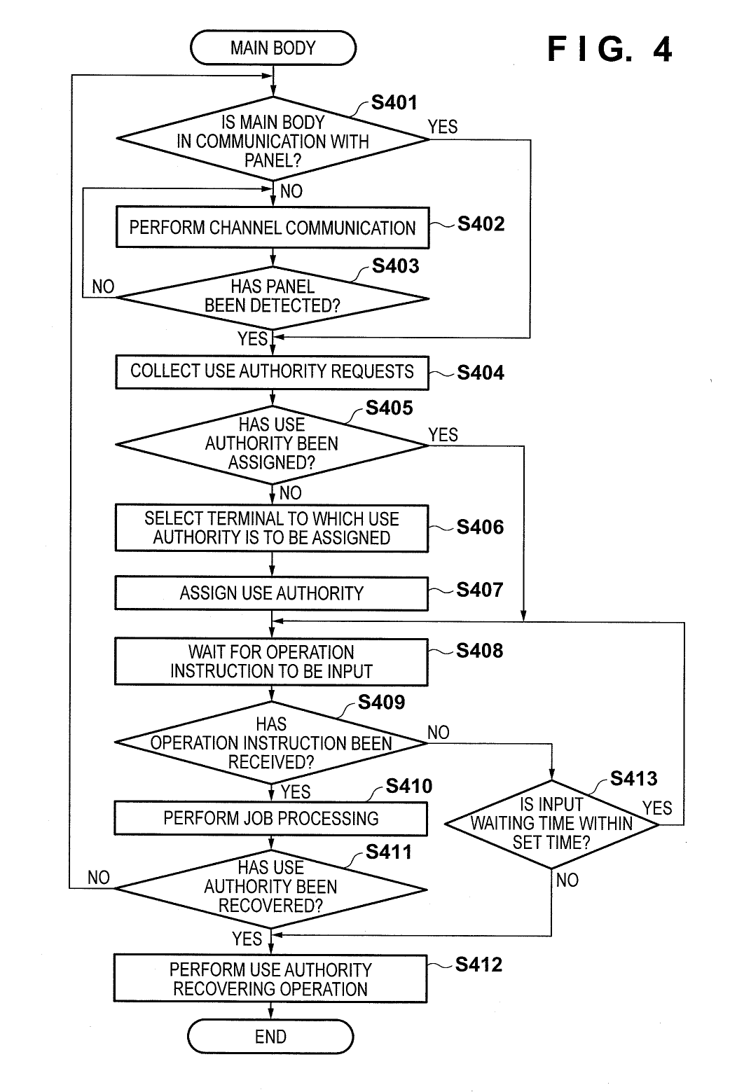

Next, preferential use authority assignment processing performed on the main body 100 side will be described with reference to FIG. 4. Overall control of the processing described below is performed by the CPU 111 of the main body 100.

First, in step S401, the CPU 111 of the main body 100 determines the wireless communication state of a main channel and determines whether or not the main body 100 is in wireless communication with an input display panel 300. If it is determined that wireless communication serving as a main channel is not established, the CPU 111 advances the processing to step S402. In step S402, the CPU 111 broadcasts information containing an ESSID so as to inform the input display panels 300 of the ESSID of the main body 100 as processing for performing main channel communication, and advances the processing to step S403. In step S403, the CPU 111 determines whether or not an input display panel 300 has been detected by determining whether or not a connection request as described above has been received from the input display panel 300, and repeats the processing of step S402 at regular time intervals until an input display panel 300 is detected.

If it is determined that an input display panel 300 has been detected (Yes in step S403), the CPU 111 transmits a response indicating that communication is permitted to the input display panel 300 so as to establish main channel communication with the input display panel 300, and advances the processing to step S404. If, on the other hand, it is determined in step S401 that the main body 100 is in wireless communication (main channel communication) with an input display panel 300 (Yes in step S401), the CPU 111 advances the processing to step S404. In step S404, the CPU 111 performs apparatus information confirming processing. Specifically, upon receiving the apparatus information confirmation request (the request to confirm the apparatus ID and apparatus information of the main body 100) transmitted from the input display panel 300, the CPU 111 obtains apparatus information held in the flash ROM 112 and transmits the apparatus information to the input display panel 300.

Next, in step S405, the CPU 111 determines whether or not the preferential use authority of the main body 100 has been assigned to the input display panel 300. If it is determined that the preferential use authority has not been assigned (No in step S405), the CPU 111 advances the processing to step S406, and executes preferential use authority assignment processing. In step S406, the CPU 111 extracts candidates for the terminal to which the preferential use authority is to be assigned from among the input display panels 300 connected to the main body 100. Subsequently, in step S407, the CPU 111 selects an input display panel 300 as the terminal to which the preferential use authority of the main body 100 is to be assigned, transmits decision notification information to the input display panel 300, and advances the processing to step S408. If, on the other hand, it is determined in step S405 above that the preferential use authority has already been assigned (Yes in step S405), the CPU 111 advances the processing to step S408.

In step S408, the CPU 111 waits for the input display panel 300 connected to the main body 100 to input an operation instruction. Subsequently, in step S409, the CPU 111 determines whether or not an operation instruction transmitted from the input display panel 300 to the main body 100 has been received. If it is determined that the operation instruction has been received (Yes in step S409), the CPU 111 advances the processing to step S410.

In step S410, the CPU 111 processes a job in accordance with the received operation instruction. Subsequently, in step S411, the CPU 111 determines whether or not the preferential use authority of the main body 100 has been recovered from the input display panel 300. If it is determined that the preferential use authority has not been recovered (No in step S411), the CPU 111 repeats the processing from step S401 to step S410. If, on the other hand, it is determined that the preferential use authority has been recovered, or in other words, the input display panel 300 has returned the preferential use authority (Yes in step S411), the CPU 111 advances the processing to step S412, where the CPU 111 functions as a canceling unit, recovers the preferential use authority from the input display panel 300 having the preferential use authority, and ends the (cancellation) processing.

If, on the other hand, it is determined in step S409 that the operation instruction has not been received (No in step S409), a waiting time for input of an operation instruction is determined in step S413. If the waiting time for input of an operation instruction is within a set time (Yes in step S413), the CPU 111 repeats the processing from step S408 and step S409. If, on the other hand, in step S413, the waiting time for input of an operation instruction exceeds the set time, or in other words, if a predetermined period of time has elapsed since the preferential use authority was assigned (No in step S413), the CPU 111 advances the processing to step S412. In step S412, the CPU 111 functions as the canceling unit, recovers the preferential use authority from the input display panel 300 having the preferential use authority, and ends the (cancellation) processing.

Preferential Use Authority

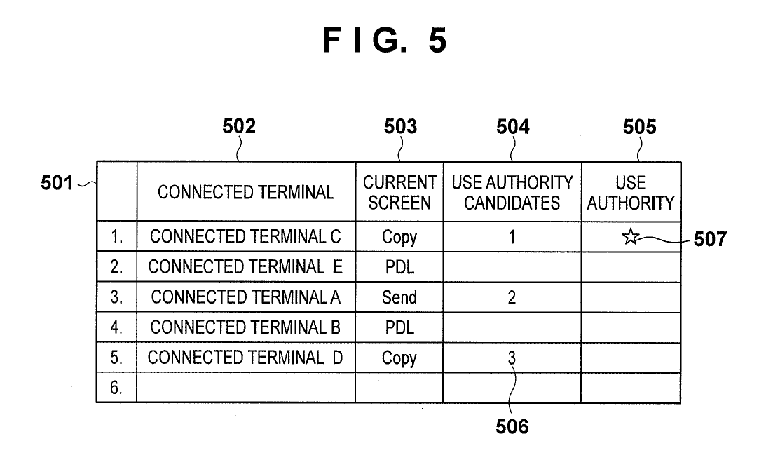

Next, the preferential use authority of the image processing apparatus and processing regarding the preferential use authority will be described with reference to FIGS. 5 to 7. Allocation of the preferential use authority assigned to an input display panel 300 will be described first with reference to FIG. 5.

As described above, the CPU 111 of the main body 100, upon receiving a connection request from the input display panel 300, generates a connected terminal list 501 in the RAM 113 and the HDD 140 of the main body 100 in step S404. The connected terminal list 501 contains connected terminal name 502, current screen information 503, preferential use authority candidate information 504 and preferential use authority assignment information 505, and the input display panels 300 are listed in the order they sent connection requests.

The current screen information 503 is information indicating the state of the screen of each input display panel 300 connected to the main body 100. When the screen of the input display panel 300 connected to the main body 100 is updated, the CPU 311 of the input display panel 300 sends screen update information to the main body 100 and sequentially updates the information. The preferential use authority candidate information 504 is information for managing candidates to which the preferential use authority is to be assigned that is updated as appropriate. It is determined whether or not the preferential use authority can be assigned in accordance with the current screen information 503 of the input display panel 300, and the terminals to which the preferential use authority can be assigned are prioritized (506), and the priority information is managed. For example, in the example of FIG. 5, the priority is given in the order of terminal C, terminal A and terminal D. The preferential use authority assignment information 505 is information for managing the terminal to which the preferential use authority is to be assigned. Specifically, in the preferential use authority assignment information 505, information 507 regarding the input display panel 300 to which the preferential use authority has been assigned is written using the preferential use authority candidate information 504. In the example of FIG. 5, terminal C has the preferential use authority.

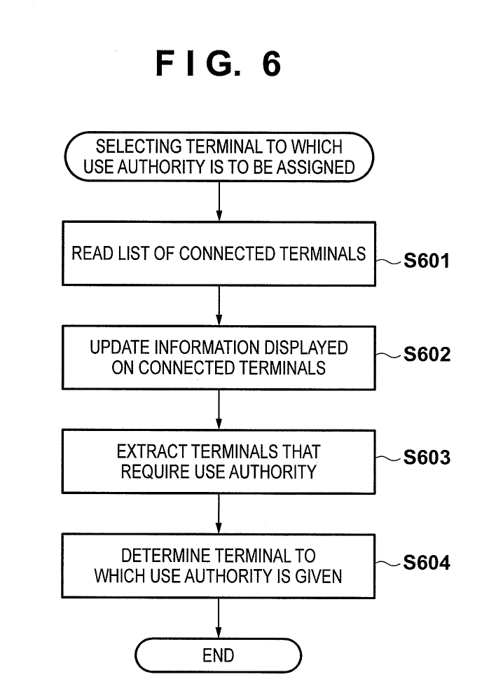

The processing procedure for selecting an input display panel 300 to which the preferential use authority is to be assigned, which is performed in step S406, will be described next with reference to FIG. 6. Overall control of the processing described below is performed by the CPU 111 of the main body 100.

In step S601, the CPU 111 detects all of the input display panels 300 that are currently connected to the main body 100. In step S602, the CPU 111 detects the screen information currently displayed on each input display panel 300 connected to the main body 100. In step S603, the CPU 111 extracts, from among all of the input display panels 300, terminals to which the preferential use authority of the main body 100 needs to be assigned. In step S604, the CPU 111 assigns the preferential use authority of the main body 100 to the oldest terminal in connection order from among the terminals to which the preferential use authority needs to be assigned and that were extracted in step S603, and ends the series of processing.

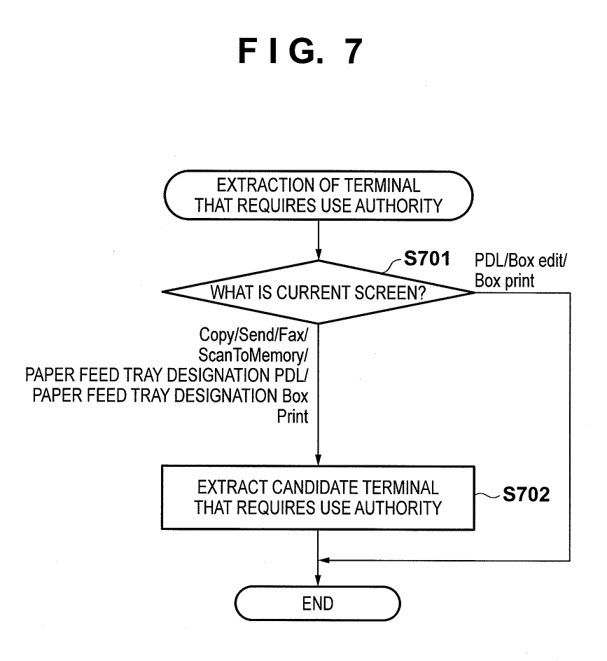

The processing for extracting input display panels 300 to which the preferential use authority needs to be assigned, which is performed in step S603, will be described next with reference to FIG. 7. Overall control of the processing described below is performed by the CPU 111 of the main body 100.

In step S701, the CPU 111 functions as a type determining unit, and determines a type of job from the current screen information of each input display panel 300 currently connected to the main body 100. If the screen information indicates a set-up screen for a job that requires setting an original to be read through copying, transmitting, faxing or the like on the scanner, a set-up screen for a job that requires setting paper in a paper feed tray, or a set-up screen for a job that outputs data to a removable storage medium, the CPU 111 advances the processing to step S702. The removable storage medium refers to, for example, a USB memory, memory card, CD, DVD or the like. In step S702, the CPU 111 extracts input display panels that require the preferential use authority of the main body 100 as candidates, and selects the terminals in the order of connection. If, on the other hand, the type of job indicated by the screen information in step S701 is one that does not require setting (placing) an original on the scanner, one that does not require setting (supplying) paper (printing material) in a paper feed tray, or one that does not output data to a removable storage medium, the CPU 111 ends the processing.

As described above, in the flowchart of FIG. 7, the type of processing (job) is determined based on the content of the set-up screen displayed on each input display panel 300, and it is determined whether or not it is necessary to assign the preferential use authority according to the type of processing. In other words, according to the present embodiment, the preferential use authority is not assigned to processing (job) that does not require assignment of the preferential use authority, and the processing is executed in the order in which execution instructions from the input display panels 300 were accepted. In the present embodiment, jobs that require an operator's action, for example, a job that requires placing an original on an original platen, and a job that requires inserting a storage medium into the image processing apparatus are defined as the jobs to which the preferential use authority needs to be assigned. However, the present invention is not intended to limit the jobs to which the preferential use authority needs to be assigned to requirements described above, and any requirements may be defined for the jobs to which the preferential use authority is to be assigned.

### Second Embodiment

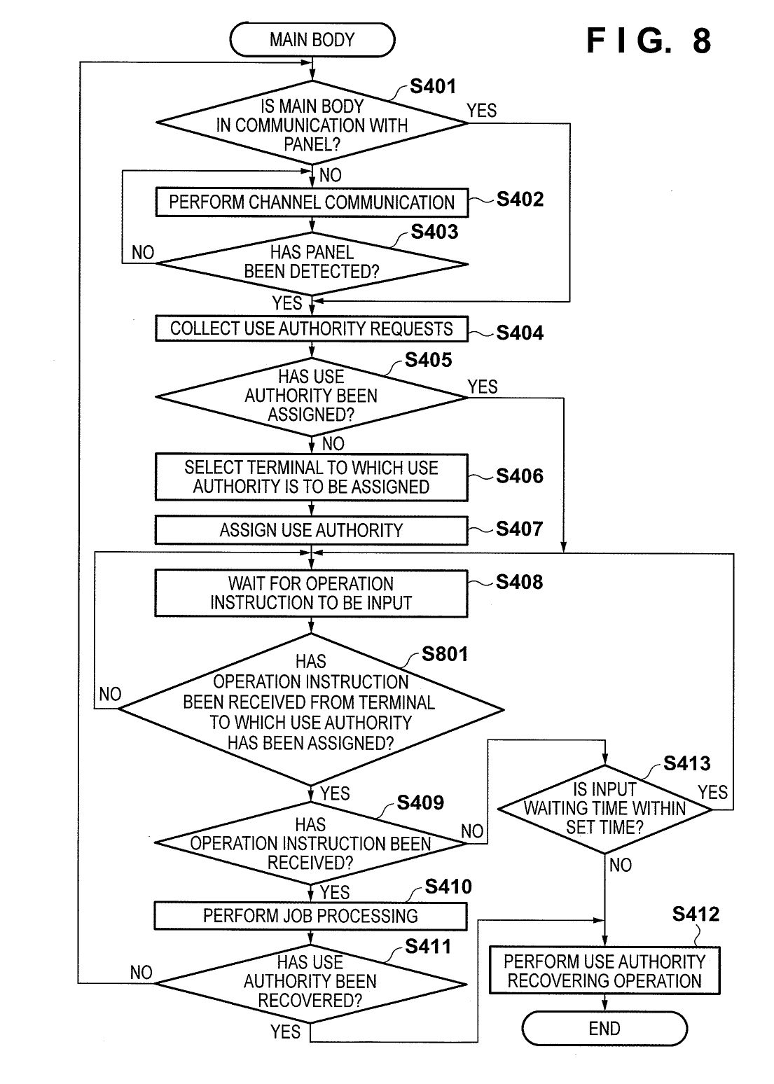

A second embodiment will be described next with reference to FIG. 8. In the present embodiment, the processing for assigning the preferential use authority of the main body 100 will be described with reference to FIG. 8, but only a difference from the flowchart of FIG. 4 will be described. Other configuration and control are the same as those of the first embodiment, and thus a detailed description is omitted here.

When step S408 ends, in step S801, the CPU 111 determines whether or not there is an operation instruction transmitted from the input display panel 300 to which the preferential use authority has been assigned to the main body 100. If it is determined that an operation instruction from the input display panel 300 to which the preferential use authority has been assigned has not been received (No in step S801), the CPU 111 returns the processing to step S408. If, on the other hand, it is determined in step S801 that an operation instruction from the input display panel 300 to which the preferential use authority has been assigned has been received (Yes in step S801), the CPU 111 advances the processing to step S409.

As described above, in the present embodiment, when an operation instruction is received from the input display panel 300 after assignment of the preferential use authority, a job is executed according to the operation instruction if the input display panel 300 is an input display panel 300 to which the preferential use authority has been assigned. In other words, the present embodiment has been conceived in consideration of the case where an operation instruction is received from an input display panel 300 to which the preferential use authority is not assigned, and a feature of the present embodiment is that if an operation instruction is received from such an input display panel, the processing moves to the step where the CPU 111 waits for the next operation instruction to be received, without executing job processing.

As described above, according to the present invention, an operation instruction from the input display panel that has obtained the preferential use authority from the image processing apparatus is preferentially processed, thereby preventing over-writing of operation instructions from occurring and reducing erroneous settings, as a result of which ease of operation by the operator can be further enhanced. It is thereby possible to enhance ease of operation by the operator.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-268723 filed on Dec. 1, 2010, which is hereby incorporated by reference herein in its entirety.

What is claimed is:

1. An image processing apparatus being capable of communicating with a plurality of input devices that request execution of a job via a wireless communication, the image processing apparatus comprising:
an obtaining unit that obtains information indicating a type of job to be executed from each of the plurality of input devices;
a selecting unit that selects an input device to which a preferential use authority of the image processing apparatus is to be assigned from among a plurality of input devices in communication with the image processing apparatus based on the information obtained by the obtaining unit; and
a job processing unit that receives an operation instruction transmitted from the input device and executes the job in accordance with the received operation instruction.

2. The image processing apparatus according to claim 1, further comprising a determining unit that determines, with respect to each of the plurality of input devices, whether or not it is necessary to assign the preferential use authority,
wherein the selecting unit selects an input device to which the preferential use authority is to be assigned from among the input devices determined by the determining unit as input devices to which the preferential use authority needs to be assigned.

3. The image processing apparatus according to claim 2,
wherein the determining unit determines that it is necessary to assign the preferential use authority if the type of job indicated by the information obtained by the obtaining unit is a job that requires placing an original to be read on the image processing apparatus, a job that requires supplying printing material used for image forming to the image processing apparatus, or a job that outputs data to a storage medium removable from the image processing apparatus.

4. The image processing apparatus according to claim 1,
wherein the information indicating the type of job obtained by the obtaining unit is screen information regarding a display screen currently displayed on the input device.

5. The image processing apparatus according to claim 1,
wherein the selecting unit selects, as the input device to which the preferential use authority is to be assigned, the oldest input device in connection order in which the plurality of input devices were connected to the image processing apparatus from among the plurality of input devices that are targets to which the preferential use authority is assigned.

6. The image processing apparatus according to claim 1,
wherein if the received operation instruction is an operation instruction from the input device to which the preferential use authority has been assigned, the job processing unit executes the job in accordance with the operation instruction.

7. The image processing apparatus according to claim 1, further comprising a canceling unit that cancels the preferential use authority from the input device to which the preferential use authority has been assigned,
wherein the canceling unit cancels the preferential use authority from the input device if the preferential use authority is returned from the input device or if a predetermined period of time has elapsed since the preferential use authority was assigned.

8. An image processing system including an image processing apparatus and a plurality of input devices that request the image processing apparatus to execute a job via wireless communication,
wherein the input devices each comprise a request unit that transmits a connection request for establishing a wireless connection with the image processing apparatus to the image processing apparatus, and
the image processing apparatus comprises:
an obtaining unit that obtains information indicating a type of job to be executed from each of the plurality of input devices;
a selecting unit that selects an input device to which a preferential use authority of the image processing apparatus is to be assigned from among a plurality of input devices in communication with the image processing apparatus based on the information obtained by the obtaining unit; and
a job processing unit that receives an operation instruction transmitted from the input device and executes the job in accordance with the received operation instruction.

9. The image processing system according to claim 8,
wherein an input device to which the preferential use authority is not assigned restricts display contents of a display screen for transmitting an operation instruction.

10. A control method of an image processing apparatus being capable of communicating with a plurality of input devices that request execution of a job via a wireless communication, the method comprising:
with an obtaining unit, obtaining information indicating a type of job to be executed from each of the plurality of input devices;
with a selecting unit, selecting an input device to which a preferential use authority of the image processing apparatus is to be assigned from among a plurality of input devices in communication with the image processing apparatus based on the information obtained in the obtaining step; and
with a job processing unit, receiving an operation instruction transmitted from the input device and executing the job in accordance with the received operation instruction.

11. A control method of an image processing system including an image processing apparatus and a plurality of input devices that request the image processing apparatus to execute a job via a wireless communication, the method comprising:
in the input devices,
with a request unit, executing a request step of transmitting a connection request for establishing a wireless connection with the image processing apparatus to the image processing apparatus, and
in the image processing apparatus,
with an obtaining unit, obtaining information indicating a type of job to be executed from each of the plurality of input devices;
with a selecting unit, selecting an input device to which a preferential use authority of the image processing apparatus is to be assigned from among a plurality of input devices in communication with the image processing apparatus based on the information obtained in the obtaining step; and
with a job processing unit, receiving an operation instruction transmitted from the input device and executing the job in accordance with the received operation instruction.

12. A computer-readable storage medium storing a computer program for causing a computer to execute the steps of the control method of an image processing apparatus according to claim 10.

13. A computer-readable storage medium storing a computer program for causing a computer to execute the steps of the control method of an image processing system according to claim 11.
